(19) United States
(12) Patent Application Publication
(10) Pub. No.: US 2022/0188558 A1
(43) Pub. Date: Jun. 16, 2022

(54) SYSTEM AND METHOD FOR INDICIA AVOIDANCE IN INDICIA APPLICATION

(71) Applicant: United Parcel Service of America, Inc., Atlanta, GA (US)

(72) Inventor: James Cossey, Snellville, GA (US)

(21) Appl. No.: 17/117,429

(22) Filed: Dec. 10, 2020

(51) Int. Cl. G06K 9/32; G06K 9/46; B65C 9/00; G06Q 50/26; B65C 9/40

(52) U.S. Cl. CPC G06K 9/3208; G06K 9/3241; G06K 9/4638; B65C 2009/0053; G06Q 50/26; B65C 9/40; B65C 9/0015

(57) ABSTRACT

Aspects herein provide a system, methods, and media for applying labels to objects without overlapping or obscuring existing labels or other indicia. In some aspects, an object in motion and labels or indicia on the object are visually identified using near real-time imaging and details of geometric characteristics are determined. An additional label is then generated, printed, and physically applied or attached to the object in motion so that the angle, placement, and orientation of the additional label matches or aligns with the existing labels or indicia, without overlapping or obscuring the existing labels or indicia.

### CROSS REFERENCE TO RELATED APPLICATIONS

This application is related by subject matter to U.S. Non-provisonal application Ser. No. 00/000,000, co-filed herewith on Dec. 10, 2020 and entitled “Label Applicator for Varied Surfaces,” which is incorporated herein by reference in its entirety.

### BACKGROUND

Applying labels to objects when in motion, for example, using a conveyor belt, results in poor or misplaced application. Specifically, the motion of the object makes it difficult to apply labels accurately. While at first blush this concern may appear de minimis, the failure to accurately apply labels to individual objects, such as packages, in the scale of billions of packages being processed daily, has astronomical consequences in terms of lost, misplaced, misrouted, and untraceable packages. For example, labels may be torn, may buckle, or may wrinkle, all of which can destroy or render machine-readable information on a label completely un-useable and un-trackable. Labels may also be applied randomly to any surface or location on the object, and may be applied askew, making it difficult for machines or personnel to locate the desired information on the label and making it difficult or impossible to scan randomly-placed labels. Additionally, labels may be applied in a manner that overlaps and covers other labels on the object, rendering those labels un-readable, un-scannable, and un-useable. As such, packages may be lost, misplaced, misrouted, and/or may become untraceable due to misapplication of labels. These problems are exponentially magnified by the fact that a single package may be processed multiple times in a single day and may have multiple labels attached to the single package at any given time.

### BRIEF SUMMARY

In one aspect, a method is provided for avoiding indicia in the application of labels to objects, such as packages. In aspects, one or more images of a package are captured. Using the images, one or more geometric characteristics of the package and a first label attached to a surface of the package are determined. Then, a second label is printed and attached to the surface of the package adjacent to the first label, based on the one or more geometric characteristics determined.

In another aspect, one or more computer-readable storage media storing computer-usable instructions are provided, that when used and/or executed by a computing device, cause the computing device to perform a method for avoiding indicia in the application of labels. In aspects, one or more images of a package are captured. Then, one or more geometric characteristics of the package and a first label attached to a surface of the package are determined, using the one or more images. A second label is printed and attached to the surface of the package adjacent to the first label, based on the one or more geometric characteristics, in aspects.

One aspect provides one or more computer-readable storage media storing computer-usable instructions are provided, that when used and/or executed by a computing device, cause the computing device to perform a method for avoiding indicia in the application of labels. In some aspects, a package in motion is identified using one or more images captured by a camera. Further, a first label that is attached to a surface of the package is identified using the one or more images, in aspects. One or more geometric characteristics of the package and the first label are determined, in various aspects, based on the one or more images. A first area on the surface of the package is determined to correspond to the first label attached to the package based on the one or more images, in aspects. In one aspect, a second area on the surface of the package is also determined based on the one or more images. A trajectory of the package may be determined and a second label may be printed, in aspects. Then, the second label can be attached to the second area on the surface of the package based on the trajectory and the one or more geometric characteristics, wherein the second label is adjacent to the first label without overlap.

### BRIEF DESCRIPTION OF THE DRAWINGS

Having thus described the invention in general terms, reference will now be made to the accompanying drawings, which are not necessarily drawn to scale, and wherein:

FIG. 1 depicts a diagram of a system for avoiding existing indicia in the application of additional labels and/or indicia to objects, in accordance with aspects of the invention;

FIG. 2 depicts a diagram of computing device, in accordance with aspects of the invention;

FIG. 3 depicts a perspective view of an example of the system of FIG. 1, in accordance with aspects of the invention;

FIG. 4 depicts a flow chart of a method for applying additional labels and/or indicia to objects, in accordance with aspects of the invention;

FIG. 5 depicts a flow chart of another method for applying additional labels and/or indicia to objects without overlap, in accordance with aspects of the invention;

FIG. 6 illustrates an overhead view of an example implementation of a system for avoiding indicia when applying a label to a package, in accordance with an aspect of the invention;

FIG. 7 illustrates the system of FIG. 6, in accordance with an aspect of the invention; and

FIG. 8 illustrates a second area determination for indicia avoidance in the example implementation of FIGS. 6 and 7, in accordance with aspects of the invention.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step,” “instance,” and/or “block” can be used herein to connote different elements of methods or system operations employed, the terms should not be interpreted as implying any particular order among or between various steps unless and except when the order of individual steps is explicitly described. The term “or” is used herein in both the alternative and conjunctive sense, unless otherwise indicated. The terms “illustrative” is used to indicate one or more examples with no indication of quality level and without imposing a restriction or limitation.

The present disclosure will now be described more fully herein with reference to the accompanying drawings, which may not be drawn to scale and which are not to be construed as limiting. Indeed, the present invention can be embodied in many different forms and should not be construed as limited to the embodiments set forth herein.

Aspects herein provide a system, methods, and media for the automated application of new or additional labels to packages in near real-time, while the packages are in motion, for example, on a conveyor. The system, methods, and media apply the new or additional labels without overlapping or overlying existing labels on the packages, and ensure that the new or additional labels have edges and sides that are aligned with one or more labels that are already affixed to the package, and that the content (e.g., barcodes, MaxiCode, text) have the same orientation as content in one or more of the existing labels that are already affixed to the package. Additionally, the system, methods, and media print the new/additional labels in near real-time by reading or scanning one or more of the existing labels that are already affixed to the package and retrieving information (e.g., a specific shipping record) that can be used to generate new or additional labels, and the new or additional labels are printed, then picked up or retrieved by an automated applicator device that applies the new or additional labels to the package without overlapping one or more of the existing labels. These aspects are achieved using the system, methods, and media that automatically determine the geometric measurements and boundaries of packages and existing labels, generate computer executable instructions to initiate new/additional label printing, and control the applicator device with detailed computer executable instructions for new/additional label placement, alignment, and overlap prevention.

Beginning with FIG. 1, a diagram of a system 100 for avoiding existing indicia in the application of labels to objects is depicted in accordance with aspects of the invention. As used herein, “indicia” can refer to computer-readable or machine-readable identifiers that may be optically scanned and/or read in an automated manner by a computing device, where the indicia encodes information as data. In some embodiments, indicia may not be human readable such that a computing device is required to read, scan, decode, and obtain the data encoded in the indicia. Alternatively, indicia may be partially human readable (e.g., alphanumerical text). Examples of indicia include barcodes, composite codes, Quick Response (QR), MaxiCodes, Aztec Codes, DataMatrix, Postnet, EAN-8, and/or the like. Accordingly, examples of indicia may be linear-type or two dimensional-type, can utilize character sets of numbers, symbols, alphabetical letters, spaces, ASCII, FNCI, ESI, and/or control codes. Further the term “label” as used herein can refer to labels having indicia as well as labels that lack indicia.

As shown in FIG. 1, the system 100 includes a computing device 102. The computing device 102 may perform one or more steps of methods discussed herein for instructing components to prevent obscuring existing indicia on an object when applying additional labels to the object, e.g., applying an additional label to a package without overlapping, partially or completely, indicia born by another previously affixed label on the package. Examples of a computing device include a personal computer (PC), a desktop computer, a physical server, a virtual server, a laptop device, a tablet device, a smartphone, a handheld computing device, a multiprocessor system, a microprocessor-based system, a minicomputer, a mainframe computer, and/or the like. In some aspects, the computing device 102 may be a plurality of devices, such as a plurality of servers, whether local or remotely distributed in the system 100.

Continuing, the computing device 102 may include components and/or subcomponents, such as a processing unit, internal system memory, and a system bus for coupling to various other components, including a data store, database, or database cluster. A system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The computing device 102 may include and/or may have access to computer-readable media. Computer-readable media can be any available media accessible by the computing device 102, and may include volatile, nonvolatile media, removable, and/or non-removable media. By way of example, computer-readable media may include computer storage media and communication media. Computer storage media may include volatile, nonvolatile media, removable, and/or non-removable media, implemented in any method or technology for storage of information, such as computer-readable instructions, data structures, program modules, or other data. In this regard, computer storage media may include, for example, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the computing device 102. Computer storage media does not comprise transitory signals (i.e., signals per se). Communication media may embody computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, communication media may include wired media, such as a wired network or direct-wired connection, and may include wireless media such as acoustic, radio frequency (RF), infrared, and other wireless media. Combinations of any of the above, which are not limiting examples, also may be included within the scope of computer-readable media.

As such, in some aspects, the computing device 102 may run and/or execute one or more computer program modules that are stored in a data store on physical or virtual memory or computer-readable media, whether locally or remotely located relative to the computing device 102. As such, aspects are discussed herein in the context of computer-executable instructions, such as program modules, being executed by the computing device 102. Program modules may include, but are not limited to, routines, programs, objects, components, applications, browser extensions, and data structures that perform particular tasks or implement particular abstract data types. In embodiments, the computing device 102 may access, retrieve, communicate, receive, and update information stored in a data store, including program modules. Accordingly, the computing device 102 may execute, using a processor, computer instructions stored in a data store in order to perform embodiments described herein.

As such, the system 100 and/or the computing device 102 may include a data store (not shown), which may be locally or remotely located in relation to the computing device 102 or other components in the system 100. A data store may electronically store information related to carrier operations, including one or more of shipper identity, shipper billing and/or pickup addresses, shipper service level, consignee identity, consignee billing and/or delivery addresses, consignee service level, shipment manifests, invoices, order numbers, shipment values, shipment insurance information, unique package or shipment codes (e.g., 1Z codes) for one or more packages, package dimensions, package weight, routing information, consolidation information, package pre-loading information, packaging tracking and monitoring information (e.g., GPS), shipment workflows, logistics information, transport vehicle information, pre-loading instructions for a package, dispatch plans, and the like. The data store may be accessible to one or more of the components and/or devices discussed above, and as such, information stored in the data store may be searched, referenced, retrieved, indexed, updated, and/or may serve as input to one or more of the components and/or devices of the system 100.

The system 100 includes a network 104 and/or utilizes a network 104 for facilitating communications between one or more of the components, in aspects. For example, the system 100 is shown in a distributed configuration in FIG. 1, where components and/or various devices may be physically or virtually remote from one another and where the component and/or various devices perform different tasks or steps. As such, in some aspects, the components and/or devices may be linked to each other and may coordinate actions and functions using the network 104. The network 104 may include wireless and/or physical (e.g., hardwired) connections to facilitate the communications and/or links between the components and/or devices in the system 100, in some aspects. Examples of suitable networks include a Wide Area Network (WAN), a Local Area Network (LAN), a Wide Area Local Network (WLAN), a Wireless Metropolitan Area Network (WMAN), a Personal Area Network (PAN), a Campus-wide Network (CAN), a Storage Area Network (SAN), a Virtual Private Network (VPN), an Enterprise Private Network (EPN), a Home Area Network (HAN), a Wi-Fi network, a short-range wireless network, a Bluetooth® capable network, a fiber optic network, a telecommunications network (e.g., 3G, 4G, LTE, 5G), a satellite network, a peer-to-peer network, an ad-hoc or “mesh” network, and any combination thereof. The network 104 may include and/or may leverage a location systems such as, for example, Global Positioning System (GPS) satellites, such as Low Earth Orbit (LEO) satellite systems, Department of Defense (DOD) satellite systems, the European Union Galileo positioning systems, the Chinese Compass navigation systems, Indian Regional Navigational satellite systems, and/or the like. The network 104 may be a singular network, or may include a plurality of networks, in various aspects. As such, the network 104 may include any combination and any variety of networks, including wireless, hardwired, telecommunication, peer-to-peer, ad-hoc, local, and/or distributed networks. The network 104 may provide the components and/or devices access to the Internet, web-based applications, and/or carrier-specific communication systems. Further, the network 104 may utilize and facilitate long range and/or short range communications of various radio frequency wavelengths.

Continuing, the system 100 includes a camera 106. The camera 106 may directly or indirectly communicate with the computing device 102, for example, to send one or more images captured by the camera 106 to the computing device 102 for analysis in near real-time with the capture. In some aspects, the camera 106 includes one or more sensors for capturing, collecting, and/or recording visual information as digital data (e.g., images and/or videos). It should be understood that videos are contemplated to be within the scope of this disclosure, although images are generally referred to herein. The visual information may be captured by the camera 106, used to generate digital images, videos, and/or augmented reality, and stored in any variety of digital file formats or as raw data in memory and/or a data store. In some aspects, visual information is collected by the camera 106 and used to generate digital still images, video, and/or augmented reality, using formats such as 360° images, Joint Photographic Experts Group (JPEG), Motion JPEG (MJPEG), Moving Picture Experts Group (MPEG), Graphics Interchange Format (GIF), Portable Network Graphics (PNG), Tagged Image File Format (TIFF), bitmap (BMP), H.264, H.263, Flash Video (FLV), Hypertext Markup Language 5 (HTML5), VP6, VP8, 4K, and/or the like. In various aspects, the system 100 may include a plurality of cameras.

In some aspects, the system 100 includes a sensor 108. The sensor 108 may be configured to sense motion, distance, proximity, weight, or the like. Examples of sensors include types and subtypes such as an optical sensor (e.g., proximity sensing), a photocell sensor, a photoelectric sensor, a laser range finding sensor, a laser trip sensor, a Light Detection and Ranging (LIDAR) sensor, an infrared sensor, an ultrasonic sensor, a magnetic field sensor, the like, and/or any combination thereof. In various aspects, the sensor 108 may include a plurality of sensors, whether of the same type or different types. The sensor 108 may provide information in near real-time to the computing device 102 and/or other system components, such as the camera 106.

The system 100 includes a conveyance device 110, for example, that can be used to transport objects in one or more directions. Herein, the terms “object” and “package” are used interchangeably and the specific use of one term instead of another is not intended to limit the scope of those aspects. Instead, packages may be discussed for clarity of description, but other objects are contemplated to be within the scope of the invention. Examples of conveyance devices includes a unidirectional and/or multi-directional belt conveyor, a chain conveyor, a passive roller conveyor, a motorized roller conveyance, a slat conveyor, an overhead conveyor, or any combination thereof. In some aspects, the conveyance device 110 may be configured to transport objects placed on one or more moveable parts or surfaces (e.g., rollers, belt, slats) of the conveyance device 110, where the object is held in place by gravity and is transported using one or more motors or mechanisms that power the parts or surfaces into motion to facilitate movement in one or more defined directions. As such, the conveyance device 110 can be used to transport one or more objects, such as packages, through a field of view of the camera and/or through a predefined physically proximity of the sensor that can thus detect the object's movement, direction, and speed, for example.

The system 100 includes a printing device 114, in some aspects. Examines of printing devices include laser printers, LED printers, inkjet printers, dot matrix printers, solid ink printers, thermal printers, and/or and like. In some aspects, the printing device 114 retrieves or receives information related to carrier operations stored in a data store, such as one or more of shipper identity, shipper billing and/or pickup addresses, shipper service level, consignee identity, consignee billing and/or delivery addresses, consignee service level, shipment manifests, invoices, order numbers, shipment values, shipment insurance information, unique package or shipment codes (e.g., 1Z codes) for one or more packages, package dimensions, package weight, routing information, consolidation information, package pre-loading information, packaging tracking information (e.g., GPS), shipment workflows, logistics information, transport vehicle information, and the like. The information may be used by the printing device 114 to print an item, such as a label, in aspects. For example, the printing device 114 may use the information retrieved or received to generate and print a unique pre-loading or shipping label that is specific to a particular package, shipper, consignee, address, shipment record, dispatch plan, vehicle, and/or the like. In further aspects, the printing device 114 prints labels in near real-time in response to receiving printing instructions generated by and received from the computing device 102. For example, based on the images from the camera 106, the computing device 102 may generate printing instructions that cause the printing device 114 to print a particular label with one or more specific text and indicia onto adhesive backed materials. Herein, the terms “label,” “preload label,” and “shipping label” are used interchangeably and the specific use of one term instead of another is not intended to limit the scope of aspects being discussed; instead, preload or shipping labels may be discussed to provide clarity of description, but other labels or tags are contemplated to be with the scope of the invention. In some aspects, the printing device 114 prints, in near real-time with detection of packages, a new or additional label to be attached to each package conveyed by the conveyance device 110.

The system 100 includes an applicator device 112, in various aspects. The applicator device 112 may be a computer controlled, robotic limb configured to receive, obtain, retrieve, or otherwise pick up an item from the printing device 114, to align an end effector of the limb with a surface of an object, and to apply the printed item to that surface of the object while the object is in motion on the conveyance device 110, in various aspects. As such, the applicator device may attach new or additional printed labels to packages in motion. In some aspects, the applicator device 112 may receive application instructions that are generated by and sent from the computing device 102 in near real-time, wherein the application instructions are used to control the robotic limb, such as complex motions, impact force, speed of motion, and articulation in three-dimensional space. As such, the application instructions may be implemented by the applicator device to retrieve a label printed by the printing device 114 and to attach the label to a particular area on a surface of a package as the package is transported by the conveyance device 110. For example, based on the images from the camera 106, the computing device 102 may generate application instructions that cause the applicator device 112 to retrieve a particular label that has been printed by the printing device 114, and that cause the applicator device 112 to apply the adhesive backed material of the label to a particular location on the surface of a package, where the detailed location information is specified in the instructions. Specifically, the particular location specified may be free of other labels and/or indicia (i.e., indicia avoidance and avoidance of overlap), in aspects. Further, the application instructions may cause the applicator device 112 to align the new or additional label being applied with one or more previously applied labels and/or indicia on the surface, such that text and/or indicia of the new or additional label is similarly angled and oriented as the text and/or indicia of one or more of the previously applied labels.

It will be understood by those of ordinary skill in the art that the system 100 is but one example of a suitable computing environment and is not intended to limit the scope of use or functionality of the present invention. Similarly, the system 100 should not be interpreted as imputing any dependency and/or any requirements with regard to each component and combination(s) of components illustrated in FIG. 1. It will be appreciated by those having ordinary skill in the art that the connections illustrated in FIG. 1 are also examples as other methods, hardware, software, and devices for establishing a communications link between the components, devices, systems, and entities, as shown in FIG. 1, may be utilized in implementation of the present invention. Although the connections are depicted using one or more solid lines, it will be understood by those having ordinary skill in the art that the examples of connections of FIG. 1 may be hardwired or wireless, and may use intermediary components that have been omitted or not included in FIG. 1 for simplicity's sake. In the same regard, though components and/or devices are represented in FIG. 1 as singular in quantity for simplicity, it will be appreciated that some aspects may include a plurality of the components and/or devices such that FIG. 1 should not be considered as limiting the number of a device or component.

Additionally, although internal components of the components and/or devices of the system 100, such as the computing device 102, are not illustrated for simplicity and brevity, those of ordinary skill in the art will appreciate that internal components and their interconnection are present in the components and/or devices of FIG. 1. Accordingly, additional details concerning the internal construction the components and/or devices of the system 100 are not further disclosed herein. Further, the absence of components and/or devices from FIG. 1 should be not be interpreted as limiting the present invention to exclude additional components and combination(s) of components.

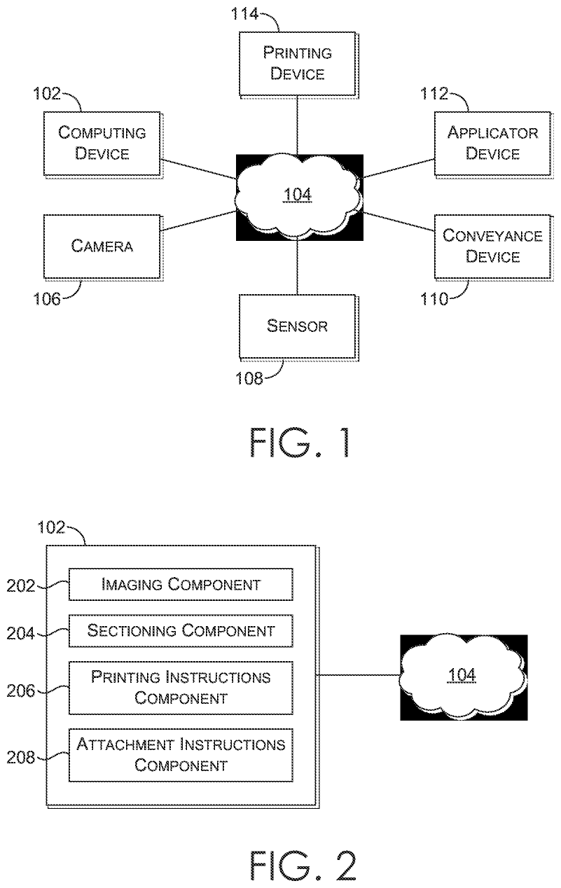

Turning to FIG. 2, a diagram of the computing device 102 is depicted, in accordance with aspects of the invention. Generally, the computing device 102 may include an imaging component 202, a sectioning component 204, a printing instructions component 206, and an application instructions component 208, in aspects. The imaging component 202, sectioning component 204, printing instructions component 206, and application instructions component 208 may each or all correspond to program modules and/or computer-readable instructions that can be executed by a processor to perform specific functions, steps, and/or methods. One or more, or all, of the imaging component 202, sectioning component 204, printing instructions component 206, and application instructions component 208 may be co-located within a single computing device that operates locally and/or may be distributed plurality of computing devices such that the location, arrangement, and quantity of the components shown in FIG. 2 should not be construed as limiting.

In aspects, the imaging component 202 may be communicatively coupled to one or more components in the system 100 of FIG. 1, such as the camera 106, the sensor 108, the conveyance device 110, and/or the applicator device 112, via the network 104, in various aspects. In some aspects, the imaging component 202 may receive digital data (e.g., one or more images or video) from the camera 106 and/or may receive proximity data, direction of travel, and/or speed information for an object in motion from the sensor 108. In one aspect, the imaging component 202 may utilize one or more images captured by the camera 106 and/or measurements of the sensor 108 to detect an object in near real time, such as a package, that is in motion via the conveyance device 110 of the system 100.

Using the one or more images, the imaging component 202 may analyze the image and determine one or more geometric characteristics of the object. Using images and/or sensor measurements as input, in some aspects, the imaging component 202 may determine one or more geometric characteristics of the object, including a leading edge (i.e., an edge or perimeter of the object that is located nearest the camera or sensor, and/or an edge or perimeter of the object that is oriented in the direction of transport along the conveyance mechanism) and non-leading edges of a package. For example, the imaging component 202 may identify and determine one or more edges, height (e.g., inches, feet, centimeters, meters), width, depth, one or more surfaces, one or more planes of a surface, one or more dimensions of the surface, a surface area of surface(s), and/or one or more surface areas of specific portions of surface(s) of the object. In some aspects, one or more geometric characteristics may include an x-, y-, and/or z-axis of the object as positioned within three-dimensional space relative to one or more of the conveyance mechanism 100, the camera 106, the sensor 108, the printing device 114, and/or the applicator device 112, as discussed regarding FIG. 1. In aspects, geometric characteristics include an angle that represents the orientation and/or angle of the object, the orientation and/or angle of a leading edge of the object, and/or the orientation and/or angle of one or more labels on the object, measured parallel to a defined direction of transport of the conveyance mechanism 100, or in relation to a position of the imaging component 202 and/or applicator device 112.

Additionally, the imaging component 202 may determine geometric characteristics of a tag and/or a label, that has been attached to the object. In some aspects, geometric characteristics of the label and/or of indicia on the label (e.g., a two-dimensional computer-readable or machine-readable symbol, barcode, MaxiCode, QR code) can be determined and identified. For example, a height and a width of each of one or more machine-readable indicia on a label can be recognized, the type of the indicia can be identified, and the geometric characteristic of the label and/or each indicia itself, can be determined by the imaging component 202. In one example, the imaging component 202 can, in near real-time with the capture of the digital images by the camera 106, determine that one label has a height of 7 inches and a width of 5 inches, can determine that the label includes one barcode and one MaxiCode, can determine the individual dimensions and surface area of each of the barcode and the MaxiCode, and can determine the position of the barcode and MaxiCode relative to one another in the label and/or other labels, indicia, and/or package edges. Accordingly, the imaging component 202 determines one or more geometric characteristics of the package and at least a first label by identifying dimensions of the surface of the package, identifying an angle of the first label on the surface, and identifying an orientation of at least one indicia, such as a machine-readable identifier, in the first label, in some aspects.

Additionally, the imaging component 202 may also decode information of one or more indicia in the label of a package as depicted in the one or more images. In some aspects, the imaging component 202 can decode machine-readable indicia and/or may use character recognition to read the label and indicia on a package in the images.

The imaging component 202 may further, in some aspects, recognize that a label corresponds to a particular carrier entity based on the geometric characteristics of the label, based on the specific types of machine-readable indicia in the label, and/or based on relative placements of each of the machine-readable indicia included in the label. For example, the imaging component 202 may determine that a label having a height of 7 inches and a width of 5 inches, and which includes one barcode and one MaxiCode is specific to a particular carrier entity (e.g., UPS, USPS, FedEx, DHL). In some aspects, the imaging component 202 may reference one or more label templates stored in a data store and determine whether the geometric characteristics, indicia types, and/or indicia placement in a label align with and/or match (e.g., identical match or using a similarity threshold) a predefined template when determining that the label is associated with a particular carrier entity. In this manner, the imaging component 202 can recognize and distinguish between different labels using template, dimensions, other geometric characteristics, machine-readable indicia types, and/or decoded indicia content. For example, the imaging component 202 can determine that one label on a package corresponds to the USPS and another label on the same package correspond to UPS. In one such example, the imaging component 202 can determine that the UPS label correspond to a specific shipping record, using real-time updated carrier information stored in a data store and accessible by the computing device 102. Accordingly, the imaging component 202 can identify and measure geometric characteristics of a package, one or more labels on the package, one or more indicia in the label(s) on the package, and can read the indicia and labels on a package.

In aspects, the imaging component 202 may determine the trajectory, speed, and/or direction of transport of the object in motion via the conveyance device 110. The trajectory, speed, and/or direction of transport of an object may be determined by comparing one or more sequentially-captured images of the object in motion and/or may be determined by communicating with a sensor 108 (e.g., a proximity sensor) and/or the conveyance device 110.

In addition to the imaging component 202, the computing device 102 includes a sectioning component 204. The sectioning component 204 may be communicatively coupled to the imaging component 202, in aspects. Using the digital images, the geometric characteristics of the object and/or indicia, and/or determinations made by the imaging component 202, the sectioning component 204 may identity and digitally bound one or more sections or areas on the surface of the object (i.e., in the digital images of the object) that lack items such as labels and/or indicia. For example, the sectioning component 204 may utilize the digital images, the geometric characteristics of the object and/or indicia, and/or determinations made by the imaging component 202, to identify and determine which specific areas on the package's surface include one or more attached labels, which specific areas are free of labels, and can measure the relative locations of label-free and label-affixed areas to one another within the edges of the package's surface. In one example, the sectioning component 204 may determine a first area on the surface of the package that corresponds to the first label attached to the package and may determine a second area on the surface of the package (i.e., lacking labels and/or lacking indicia) that does not correspond to the first label, based on the images. It should be understood that terms such as “first,” “second,” “third,” and so forth are used herein for the purposes of clarity in distinguishing between elements or features, but the terms are not used herein to import, imply, or otherwise limit the relevance, importance, quantity, technological functions, and/or operations of any element or feature unless specifically and explicitly stated as such.

In one example, the sectioning component 204 may portion the surface of the package into a matrix, using the one or more images. Then, the sectioning component 204 may identify one or more portions of the matrix that correspond to the first label, and further, may identify one or more other portions of the matrix that do not correspond to the first label, in the example. The one or more other portions may lack labels and/or indicia. In an example, the sectioning component 204 may determine the a second label is to be attached to a location on the surface that corresponds to the one or more other portions of the matrix identified. In this manner, a second label can be affixed to a package without overlapping or overlying, and thus obscuring, another previously-attached label with indicia on the package. As such, prior to causing a new or additional label (i.e., a second label) to be attached to the surface of the package, the sectioning component 204 can identify one or more specific locations or area on the surface of the package for placement of the second label based on the one or more geometric characteristics of the package and the first label. Therefore, the sectioning component 204 may use information from the imaging component 202 when identifying one or more areas on the package's surface that are free of indicia on the object.

In further aspects, the imaging component 202 may decode indicia in a first label and, based on decoding, may determine that the first label corresponds to a particular carrier entity. Then, the sectioning component 204 may use this information to determine an first area of the surface of the package that corresponds to the first label that is specific to a first carrier entity (e.g., the area may include labels of other carrier entities however). In such an example, the sectioning component 204 may identify a second area that is adjacent to the first label. Based on the second area being adjacent to the first label and based on the first label corresponding to the particular carrier, the sectioning component 204 may determine that the second label is to be attached to the package at the second area. In this manner, a second label can be affixed to a package without overlapping or overlying, and thus obscuring, another previously-attached carrier-specific label with indicia. When attached, the second label and the first label are adjacent and do not overlap one another. In such an example, the second label might be placed in the second area to overlap or overlay other labels that correspond to other carrier entities, however. Accordingly, the indicia avoidance techniques discussed herein may be generalized such that additional labels can be applied to a package while avoiding overlapping all previously-attached labels, or may be specialized such that additional labels can be applied to a package while only avoiding overlapping previously-attached labels that correspond to a particular carrier, in various aspects.

In an alternative aspect, the second label may be attached to the surface of the package to partially or completely overlap the first label to purposefully obscure and/or replace the first label as this may be desired in specific scenarios (e.g., when a first label is not applicable or is obsolete regarding the remaining portions of tracking and shipment of a package; when a first label includes inaccurate or unreadable information due to damage or soiling; when a change in routing has occurred based on carrier system updates such that the information encoded in the first label is no longer up-to-date).

Continuing, the computing device 102 may include a printing instructions component 206. As such, the computing device 102 can cause new or additional labels to be printed for attachment to the second area that has been identified by the sectioning component 204, in some aspects. In aspects, the printing instructions component 206 generates computer executable instructions that cause the printing device 114 to print an item for application to the object, such as a label with adhesive backing. For example, the printing instructions component 206 may utilize information obtained or determined by the imaging component 202, such as carrier information and/or information from decoded indicia in the images, to retrieve a shipping record stored in a data store or accessible on a carrier entity network. Using the shipping record, the printing instructions component 206 may digitally generate a label and computer executable instructions that cause the label to be physically printed by the printing device 114 onto a material that is capable of attachment to an object. Further, these actions of the printing instructions component 205 may be performed in near real-time with the processing of images by the imaging component 202 and/or with the determinations of the sectioning component 204. In an aspect, subsequent to or concurrently with identifying, via the imaging component 202, a first label and geometric characteristics of the first label that is already attached to the package, the printing instructions component 206 may generate computer instructions for the printing device 114 and may cause a second label to be printed by the printing device 114 for attachment to the package having the first label.

The computing device 102 includes an application instructions component 208 that causes a new or additional printed label (i.e., a second label) to be physically attached to a package's surface within an area or at a location on the package's surface that has been selected by the sectioning component 204 (i.e., a second area) so as not to overlap with another previously attached label (i.e., a first label) on the same package. This second newly-printed label may be attached to the package by using application instructions that cause an applicator device 112 to retrieve the second label from the printing device 114 and attach the second label to the package, in aspects. The application instructions may be generated by the application instructions component 208 of the computing device 102. The computer instructions may include and specify an elevation of the surface of the package to which the second label is to be attached, the elevation being relative to the rise of the package above the conveyance device 110, in aspects. As such, the elevation may have been measured as a geometric characteristic by the imaging component 202 by calculating the total pixel quantity of one or more fixed dimension geometric shapes (e.g., concentric circles) appearing on the surface of the package, as captured within the images. For example, the imaging component 202, previously discussed, may determine the surface of the package has an elevation rising 0.35 meters above the conveyance device, when there is a total quantity of 400 pixels for the width of the fixed dimension geometric shape appearing on the package's surface. This is just one non-limiting example, however, and other techniques for determining and measuring the package's surface elevation are contemplated to be within the scope of the aspects discussed herein.

The computer executable application instructions generated by the application instructions component 208 may also specify an area, location, portion, and dimensions thereof located on the surface of the package to which the second label should be attached, by translating the pixels of the images into physical dimensions. The computer executable application instructions may further specify a predicted location or actual location of the package in motion on the conveyance device 110, for example, by using the camera 106 to assist the applicator device 112. As such, the applicator device 112 may execute the instructions generated by the application instructions component 208, may move and/or articulate a limb to retrieve and pick up a printed label from the printing evince 114, may move and/or articulate the limb above the package's surface, may aim the end effector, and may motion and/or articulate the limb to strike and deposit the new or additional “second” label onto the designated portion of the package's surface, via the end effector, at the specific location, angle and orientation specified in the instructions generated by the application instructions component 208.

As such, the computer executable instructions generated by the application instructions component 208 may specify a degree of rotation and/or an angle for the new or additional “second” label to be applied so that the second label is in alignment with the first label based on the geometric characteristics of both the package and the first label. The degree of rotation and/or an angle may be determined by the imaging component 202 and/or the sectioning component 204 based on the images and/or determined geometric characteristics, in some aspects. As such, the applicator device 112 may execute the computer executable application instructions and can manipulate the second label to be rotated using the degree of rotation and/or angel and then attach the second label to the package's surface while in motion on the conveyance device 110, for example, by using the camera 106 to assist the applicator device 112 is aiming and striking the package. For example, the applicator device 112 may execute the instructions generated by the application instructions component 208, to retrieve and pick up a printed second label with an end effector, articulate the limb above the package using the degree of rotation to align the second label with the first label on the package, aim the end effector toward a designated location for applying the second label as specified in the instructions, and motion the limb to deposit the second label onto the designated portion of the package's surface, via the end effector. As applied in such aspects, the second label does not overlap with the first label, the second label is aligned with the degree of rotation and/or the angle of the first label, and the text and/or indicia of the second label are oriented in the same manner as any text and/or indicia on the first label.

It should be understood that other internal components of the computing device 102 are not illustrated for simplicity and brevity, and those of ordinary skill in the art will appreciate that internal components and their interconnection can be present in the computing device 102 of FIG. 2. Accordingly, additional details concerning the internal construction the computing device 102 are not further disclosed herein. Further, the absence of other external or internal components or device in FIG. 1 should not be interpreted as limiting the computing device 102 to exclude additional components, devices, or combination(s) thereof.

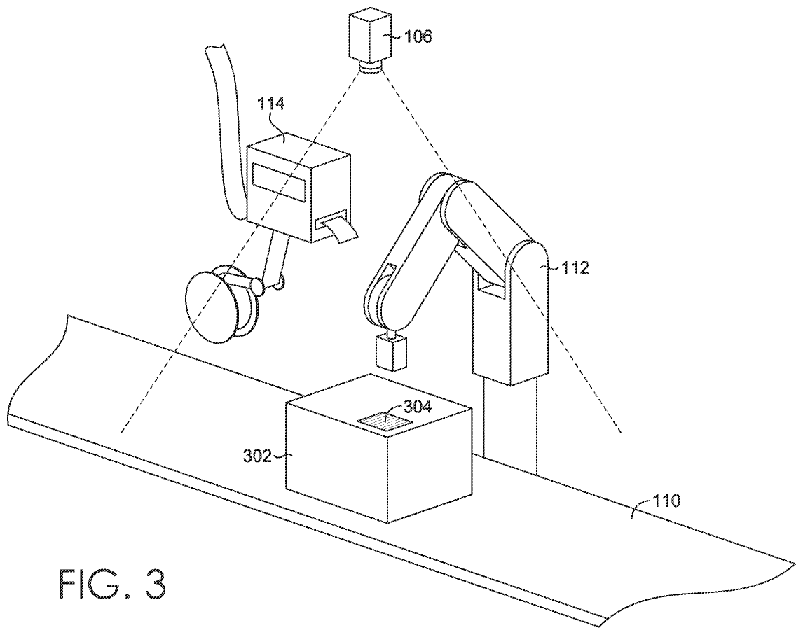

For example, FIG. 3 illustrates a perspective view of an example implementation of the system 100 and components of FIGS. 1 and 2. In FIG. 3, the camera 106, the printing device 114, and the applicator device 112 are arranged in proximity to the conveyance device 110. In the example shown in FIG. 3, the camera 106 may be physically placed above or over some portion of the conveyance device 110 upon which objects can be placed and transported, thus passing through the field of view of the camera 106. As such, the camera 106 may be positioned to capture a “birds eye” field of view of an object 302 having a label 304 that is being transported via the conveyance device 110, in some aspects. The field of view created by the placement and positioning of the camera 106 may also be adjusted and/or changed while remaining within the scope of the aspects described herein. The arrangement, distance, and sequence of the system 100 components along the conveyance device 110, and the orientation of the camera 106, are merely one example, and are not intended to be limiting. In FIG. 3, for example, a printing device 114 may print a new or additional label using computer instructions generated by the printing instructions component 206, and an applicator device 112 may attach the new or additional label to the object 302 using computer instructions generated by the application instructions component 208, while the object is transported along the conveyance device 110. The new or additional label may be attached to the object to avoid and prevent overlap with an existing label 304, in aspects.

Having described an example system 100 and components thereof in FIGS. 1-3 it will be understood by those of ordinary skill in the art that the system 100 is but one example of a suitable system and is not intended to limit the scope of use or functionality of the present invention. Similarly, the system 100 should not be interpreted as imputing any dependency and/or any requirements with regard to each component and combination(s) of components illustrated in FIGS. 1-3. It will be appreciated by those of ordinary skill in the art that the location of components illustrated in FIGS. 1-3 is an example, as other methods, hardware, software, components, and devices for establishing a communication links between the components shown in FIGS. 1-3, may be utilized in implementations of the present invention. It will be understood to those of ordinary skill in the art that the components may be connected in various manners, hardwired or wireless, and may use intermediary components that have been omitted or not included in FIGS. 1-3 for simplicity's sake. As such, the absence of components from FIGS. 1-3 should be not be interpreted as limiting the present invention to exclude additional components and combination(s) of components. Moreover, though components are represented in FIGS. 1-3 as singular components, it will be appreciated that some embodiments may include a plurality of devices and/or components such that FIGS. 1-3 should not be considered as limiting the number of a device or component.

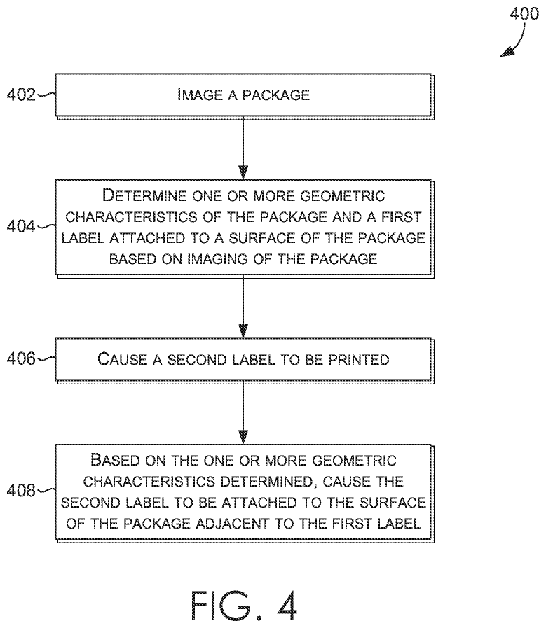

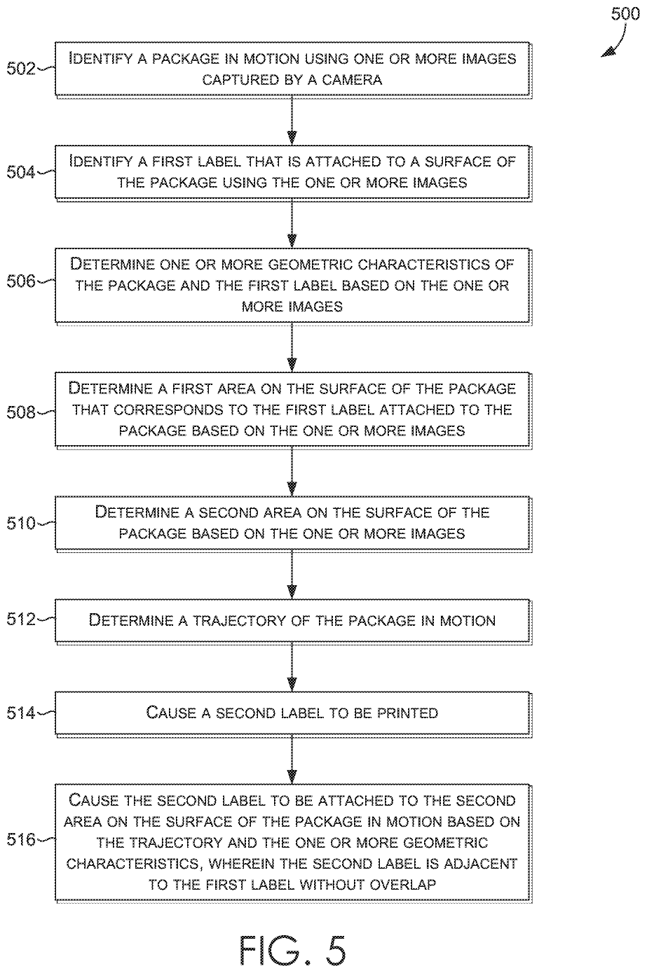

Turning now to FIGS. 4 and 5, methods are discussed that can be performed via one or more of the system components and component interactions previously described in FIGS. 1 to 3. As such, the methods are discussed with brevity, though it will be understood that the previous discussion and details described therein can be applicable to aspects of the methods of FIGS. 4 and 5. Additionally or alternatively, the methods discussed herein can be implemented or performed using a computing device, such as the computing device 102 of FIG. 2. For example, the methods may be performed by executing computer-readable instructions and/or computer-readable program code portions stored and/or embodied on computer-readable storage media, by one or more processors. In one example, one or more non-transitory computer-readable storage medium having computer-readable program code portions embodied therein is used to implement and perform one or more steps of the methods using one or more processors to run and/or execute the program code portions, where those program code portions are specially configured to perform the steps of the methods. The computer-readable instructions or computer-readable program code portions can specify the performance of the methods, can specify a sequence of steps of the methods, and/or can identify particular components, devices, software, and/or hardware for performing one or more of the steps of the methods, in embodiments.

FIG. 4 depicts a method 400 for avoiding existing indicia in the application of additional labels to a package. In embodiments, avoiding existing indicia can refer to placing an additional label onto a package without overlapping, partially or completely, one or more indicia of one or more existing labels previously affixed to a package. In some embodiments, avoiding existing indicia can refer to placing an additional label onto a package without overlapping, partially or completely, the entirely of a label bearing on indicia, and/or one or more particular portion(s) of a label that bear an indicia, as previously affixed to a package.

In aspects, one or more images of the surface of the package are captured using the camera 106 while the package is in motion by way of the conveyance device 110. At block 402, an imaging component 202 of a computing device 102 receives one or more images of a package, for example, captured by the camera 106. The imaging component 202 may analyze the one or more images to identify a package, one or more labels on the package, and to distinguish the package from other packages in the field of view, and/or to distinguish between one or more labels on a package, in various aspects. In one aspect, the imaging component 202 identifies a package as a subject for further image analysis, and disregards other objects in the images, such as background objects.

At block 404, an imaging component 202 of a computing device 102 determines one or more geometric characteristics of the package and a first label attached to a surface of the package based on one or more images of the package. In various aspects, the one or more geometric characteristics include dimensions of the package, an elevation of the package, a leading edge of the package, an angle of the package, dimensions of the first label, an angle and/or orientation of the first label, dimensions of an indicia, and/or an angle or orientation of an indicia, such as a machine-readable identifier, of the first label. Although the first label is discussed herein as an example, it should be understood that geometric characteristics of multiple labels and multiple indicia on a single package can be determined from the one or more images.

At block 406, a printing instructions component 206 of a computing device 102 causes a second label to be printed, for example, by a printing device 114, as previously discussed. For example, using the one or more images and/or information decoded from a first label and/or indicia of the first label, a shipping record that is specific to the package can be retrieved and used to generate the second label and to cause the second label to be printed in anticipation of attaching the second label to the package.

At block 408, based on the one or more geometric characteristics determined, an application instructions component 208 of a computing device 102 causes the second label to be attached to the surface of the package adjacent to the first label, for example, by controlling an applicator device 112. In aspects, the second label and the first label do not overlap one another when the second label is attached to the surface of the package, as previously discussed.

In one aspect for preventing such overlap, a sectioning component 204 2 identifies a specific area on the surface of the package for placement of the second label based on the one or more geometric characteristics of the package and the first label. In one such aspect, the specific area identified is selected as the second area become the area is adjacent to the first label and does not overlap with the first area of the package to which the first label is attached. Then, the application instructions component 208 may cause the second label to be attached to the area using the applicator device 112 to execute instructions.

In some aspects for preventing overlapping labels on the same package, the imaging component 202 and/or the sectioning component 204 may determine a degree of rotation or angle for the second label that will align the second label with the first label, based on the one or more geometric characteristics of the package and the first label. In such an aspect, the imaging component 202 and/or the sectioning component 204 may measure an angle of a leading edge of the package relative to the leading edge of the first label, and use this measured angle to adjust the application of the second label to the package to a degree of rotation. When attached to the surface of the package, by causing the second label to be rotated using the degree of rotation via the applicator device 112, the edge of the second label will be in alignment with and parallel to the edge of the first label (i.e., not askew), without overlapping the first label.

In further aspects for preventing overlapping labels on the same package, a sectioning component 204 may portion the surface of the package into a matrix, using the one or more images. Then, the sectioning component 204 may identify one or more portions of the matrix that correspond to the first label, in such aspects. The sectioning component 204 may further identify one or more other portions of the matrix that do not correspond to the first label and then, may determine to attach the second label to a location on the surface that corresponds to the one or more other portions of the matrix that do not correspond to the first label. As such, the application instructions component 208 may generate instructions for the applicator device 112 to attach a second label that has been printed to the location identified and designated by the sectioning component 204.

Additionally, in aspects for avoiding overlapping label application, the imaging component 202 may decode the first label in the images and may reference up-to-date carrier information in a data store using the decoded information in the first label as a query. For example, the decoded information may be used to retrieve shipment and tracking information that is specific to the package bearing the first label. In this manner, based on decoding the first label and using information from the first label, the imaging component 202 may search for, identify, and retrieve new and/or additional carrier information that is to be encoded in a second label for that specific package. In one such aspect, the printing instructions component 206 utilizes the retrieved carrier information when generating and sending instructions to print the second label to the printing device 114. As such, the second label may include some or all of the retrieved carrier information and the second label may have a particular format and/or may conform with a carrier specific label template.

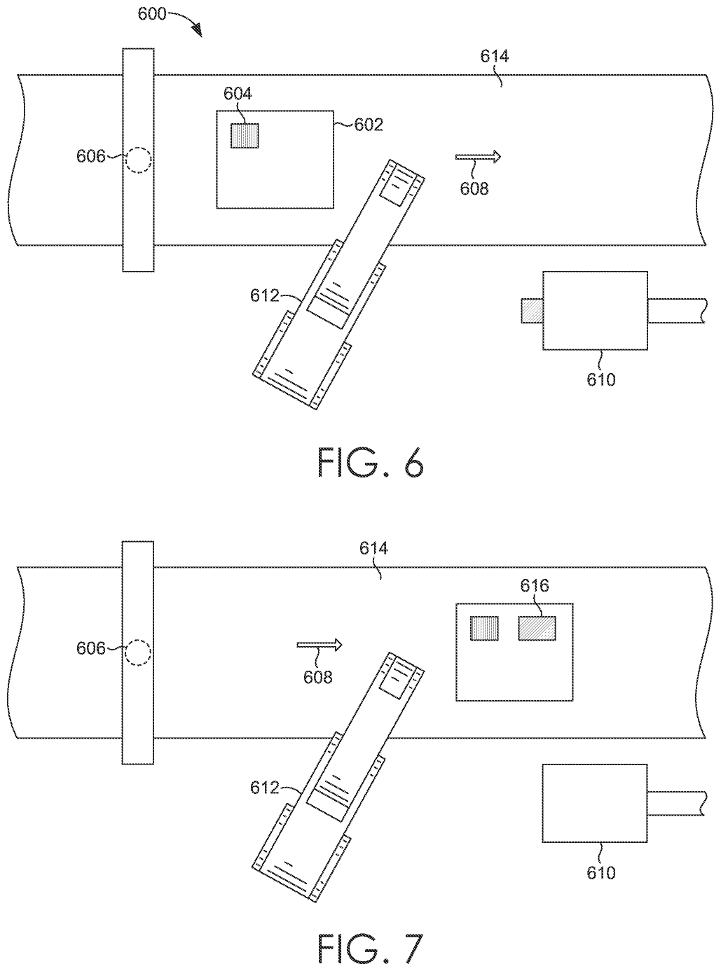

Turning now to FIG. 5, another method 500 is depicted for avoiding existing indicia in the application of additional labels to a package. Beginning at block 502, a package in motion is identified using one or more images captured by a camera. The package may be identified by the imaging component 202 and/or the sensor 108, using the images or other sensor data, in some aspects. For example, FIG. 6 illustrates an overhead view of an example implementation 600 for avoiding indicia when applying a label to a package. In FIG. 6, the images captured using an overhead camera 606 are used by an imaging component of a computing device (not visible) to identify that a particular package 602 that is moving in a direction of travel 608 facilitated by a conveyance device 614. At block 504, a first label that is attached to a surface of the package is identified using the one or more images. For example, in FIG. 6, the images captured using the overhead camera 606 are used by an imaging component to identify the first label 604 on the upward-facing surface of the package 602. In some aspects, an imaging component may identify and distinguish between one or more labels, indicia, text, and/or logos, including the first label, that are visible at the surface of the package by analyzing the digital images.

At block 506, one or more geometric characteristics of the package and the first label are determined based on the one or more images. In one aspect, as shown in FIG. 6, images of the package 602 are captured in near real-time as the package 602 is in motion along the conveyance device 614 where the camera 606 is positioned directly overhead to capture a bird's eye view of an upward-facing surface of the package 602 (e.g., as opposed to a bottom-facing surface of the package which rests against the conveyance device 614). In such an aspect, an imaging component may measure and determine the height of the package 602 based on the elevation of the upward-facing surface of the package 602 over the conveyance device 114. To determine the height or elevation, the imaging component may, using the images, calculate a total pixel quantity of one or more fixed dimension geometric shapes (e.g., concentric circles have a define diameter of two inches, not shown) appearing on the surface of the package 602, as previously discussed. In one example, the imaging component may determine the total number of pixels of the diameter of one or more fixed-size concentric rings visible to the camera on the first label and/or the surface of the package. In such an example, the imaging component may determine that surface of the package has a height or elevation of 0.54 meters above the conveyance device 614, based on there being a count of 412 pixels for the diameter of one or more fixed-size concentric rings on the label 604 and/or on the package's surface, in reference to the defined diameter of two inches.

In some aspects of the method 500, a first label may be decoded in addition to determine geometric characteristics. In other words, one or more indicia, such as a machine-readable identifier, may be scanned and read, and automatically decoded to obtain the information of the first label, in some aspects. In an aspect, based on decoding the first label, an imaging component or sectioning component, for example, may determine whether the first label corresponds to a particular carrier entity. In one example, a first label may be determined to be associated with a particular carrier based on the content of the information encoded in the first label. Additionally or alternatively, the first label may be determined to be associated with a particular based on dimensions of the first label and inclusion of one or more specific types of indicia (e.g., machine-readable identifiers), in an example. An imaging component may reference predefined carrier-specific label templates and/or a carrier system when determining whether the first label is specific to a particular carrier entity. Further, in some embodiments, the imaging component may determine when one or more other labels are associated with other carrier entities. The labels associated with other carrier entities may be disregarded when determining a location on a package's surface to apply the second label, in some aspects.

Continuing to block 508, a first area on the surface of the package that corresponds to the first label attached to the package is determined, based on the one or more images. Generally, the first area corresponds to only one portion of the physical surface of the package to which the first label has been applied. The first area may be identified by an imaging component and/or a sectioning component, in various aspects. For example, a sectioning component may portion the surface of the package in the images into segments or a matrix, and the imaging component may perform contrast analysis between pixels, segment, and/or cells in a matrix, in order to determine which portion(s) of the package surface in the images correspond to the first label. In another example, an imaging component may, having identified a first label as belonging to a specific carrier entity based on geometric characteristics and/or a carrier-specific label template, automatically identify the first area by making inferences from the information obtained from the geometric characteristics and/or a carrier-specific label template.

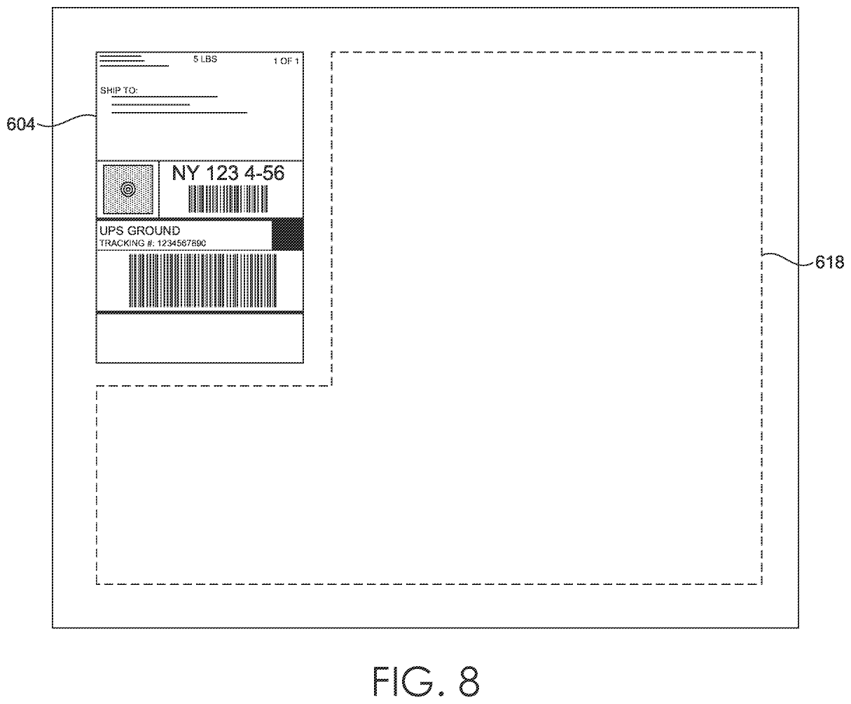

At block 510, an sectioning component may determine a second area on the surface of the package that does not correspond to the first label, based on the one or more images. As visible in FIG. 8, a second area 618 is determined on the package 602, where the second area 618 specifically lacks the first label 604, and may further lack any labels or indicia, in one such example implementation. In some aspects, a sectioning component may portion the surface of the package in the images into segments or a matrix, while disregarding and/or purposefully omitting the first area from the portioning process. In various aspects, the sectioning component determines which portion(s) of the package surface are available for applying a second label, as these portions are free of the first label. In one aspect, the sectioning component may specifically identify, select, and designate one or more portions that are physically adjacent to the first area and which have overall dimensions that can, at least, accommodate a predefined label size, as a second area for future label application. In the example of FIG. 8, dashed lines represent the boundaries of a second area 618 determined, for example, by a sectioning component, where the second area 618 is determines to be free of the first label 604 such that application of a second label within the second area 618 will prevent overlap or obscuring of the first label 604.

In one aspect, a sectioning component may portion the one or more images of the surface of the package into a matrix, the matrix having a plurality of segments. Then, the sectioning component and/or imaging component may calculate, analyze, and determine contrast differences between the plurality of segments. The sectioning component may then, in some aspects, identify a portion of adjacent segments in the plurality that have contrast differences that meet a threshold. In one such aspect, the sectioning component may determine to attach or apply a second label to a portion (e.g., designated as a second area) at the surface of the package that corresponds to the portion of adjacent segments determined to meet the contrast threshold.

In further embodiments, the second area may be identified as being adjacent to the first label that has been determined to correspond to a particular first carrier entity, and the second area may or may not include other labels that correspond to other carrier entities. As such, by selecting the second area (to which the second label can be applied and where the second label corresponds to the same first carrier entity) as being adjacent to the first area of the carrier-specific first label, the carrier-specific labels can be grouped together on the package's surface.

Turning to block 512, a trajectory of the package in motion is determined. The trajectory may be determined as a traveling speed and a direction of travel of the package, in aspects. The trajectory may be determined by an imagining component using one or more images and/or video captured by a camera and/or data measured by a sensor. As such, the present location of the package and the predicted location and time that the package will be within a defined proximity (e.g., within a range of motion of an articulating arm) of an applicator device can be determined in advance of the package's arrival at that proximity/location at the predicted time. Further, the predicted location and time when the designated second area on the package's surface will be within a defined proximity (e.g., within a range of motion) of an applicator device can be determined in advance of the package's arrival. As such, the trajectory can include information regarding the second area on the package's surface, to which the second label is anticipated to be applied.

At block 514, a second label is printed, for example, by a printing device using computer executable instructions generated by a printing instructions component. In some aspects, the second label is printed in advance of the package's arrival within the range of motion of the applicator device. In this manner, the applicator device can retrieve the second label and prepare to apply the second label to the package, by using and executing application instructions received from an application instructions component, in aspects. At block 516, the second label becomes attached to the second area on the surface of the package in motion based on the trajectory and the one or more geometric characteristics determined, wherein the second label is adjacent to the first label without overlap between the two labels. In aspects, the second label becomes attached to the second area on the surface of the package, in real time, while the package is in motion. For example, FIG. 7 illustrates the overhead view of the implementation 600 of FIG. 6 with a new second label 616 that has become attached to the package 602 adjacent to and in alignment with the first label 604.

In some aspects, the second label becomes attached to the second area on the surface of the package based on the trajectory and the one or more geometric characteristics, such as an angle of the first label. For example, an imaging component may determine an angle of the first label relative to the leading edge of the package, based on the one or more images. Then, in the example, the applicator device may be controlled to rotate the second label to be in alignment and parallel to the angle of the first label. Further, in this example, the second label may then be applied to the second area of the package's surface adjacent to and parallel to the first label. As such, when the second label is attached to the second area, and the second label aligns with the angle of the first label without overlap.

In further aspects, the second label becomes attached to the second area on the surface of the package based on the trajectory and the one or more geometric characteristics, such as an angle of the first label and the orientation of at least one indicia, such as a machine-readable identifier, of the first label. In one example, an imaging component may identify one or more overall dimensions of the surface of the package (e.g., boundaries of the surface), an angle of the first label on the surface, and an orientation of at least one indicia, such as a machine-readable identifier, in the first label. For example, a barcode may be oriented lengthwise and/or parallel or nearly parallel to a leading edge of the first label and/or leading edge of the package. In this example, the second label may be applied to the second area on the surface of the package, wherein the second label is located within the overall dimensions of the surface, is in alignment with the angle of the first label, and wherein the second label and/or indicia of the second label have the same orientation of the at least one machine-readable identifier of the first label. For example, a barcode on the second label is oriented lengthwise and/or parallel or nearly parallel to a leading edge of the first label and/or leading edge of the package, similar to the barcode on the first label. In another example, other indicia (e.g., text or MaxiCode) on the second label may have the same orientation as similar indicia on the first label. Accordingly, a second label can be attached to a package to be in alignment with and having the same orientation as a previously-attached first label on the same package, while preventing overlap of the labels which would rendering the first label un-readable, un-scannable, and un-useable, and which could result in lost, misplaced, misrouted, and untraceable packages.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving one or more images of a package;
determining one or more geometric characteristics of the package and a first label attached to a surface of the package based on the one or more images of the package;
causing a second label to be printed; and
based on the one or more geometric characteristics determined, causing the second label to be attached to the surface of the package adjacent to the first label.

2. The method of claim 1, wherein the second label and the first label do not overlap one another when the second label is attached to the surface of the package.

3. The method of claim 1, further comprising:
prior to causing the second label to be attached to the surface of the package, identifying an area on the surface of the package for placement of the second label based on the one or more geometric characteristics of the package and the first label; and
causing the second label to be attached to the area, wherein the area is adjacent to the first label.

4. The method of claim 1, further comprising:
prior to causing the second label to be attached to the surface of the package, determining a degree of rotation for the second label to be in alignment with the first label based on the one or more geometric characteristics of the package and the first label; and
causing the second label to be rotated using the degree of rotation and attached to the surface of the package.

5. The method of claim 1, wherein imaging the package comprises:
capturing one or more images of the surface of the package using a camera while the package is in motion; and
using the one or more images, portioning the surface of the package into a matrix.

6. The method of claim 5, further comprising:
identifying one or more portions of the matrix that correspond to the first label;
identifying one or more other portions of the matrix that do not correspond to the first label; and
determining to attach the second label to a location on the surface that corresponds to the one or more other portions of the matrix.

7. The method of claim 1, further comprising:
decoding the first label; and
based on decoding the first label, identifying information to be encoded in the second label.

8. The method of claim 1, further causing the second label to be attached to the surface of the package by partially or completely overlapping the first label.

9. One or more computer-readable storage media storing computer-usable instructions that when used by a computing device, cause the computing device to perform a method, the method comprising:
identifying a package in motion using one or more images captured by a camera;
identifying a first label that is attached to a surface of the package using the one or more images;
determining one or more geometric characteristics of the package and the first label based on the one or more images;
determining a first area on the surface of the package that corresponds to the first label attached to the package based on the one or more images;
determining a second area on the surface of the package based on the one or more images;
determining a trajectory of the package in motion;
causing a second label to be printed; and
causing the second label to be attached to the second area on the surface of the package in motion based on the trajectory and the one or more geometric characteristics, wherein the second label is adjacent to the first label without overlap.

10. The method of claim 9, wherein the second label becomes attached to the second area on the surface of the package, in real time, while the package is in motion.

11. The method of claim 9, further comprising:
decoding the first label; and
based on decoding, determining that the first label corresponds to a particular carrier.

12. The method of claim 11, further comprising:
based on determining that the first label corresponds to the particular carrier, identifying the second area that is adjacent to the first label; and
based on the second area being adjacent to the first label that corresponds to the particular carrier, determining to attach the second label to the second area on the package.

13. The method of claim 11, wherein the first label is determined to correspond to the particular carrier based on dimensions of the first label and inclusion of one or more specific types of machine-readable identifiers.

14. The method of claim 9, further comprising:
determining an angle of the first label based on the one or more images;
controlling an applicator device to rotate and align the second label with the angle of the first label prior to attaching to the second area; and
wherein when the second label is attached to the second area, and the second label aligns with the angle of the first label without overlap.

15. The method of claim 9, wherein determining the one or more geometric characteristics of the package and the first label comprises:
identifying dimensions of the surface of the package;
identifying an angle of the first label on the surface; and
identifying an orientation of at least one machine-readable identifier in the first label.

16. The method of claim 15, wherein the second label is attached to the surface of the package: within the dimensions of the surface, in alignment with the angle of the first label, and matching the orientation of the at least one machine-readable identifier.

17. The method of claim 9, further comprising:
portioning the one or more images of the surface of the package into a matrix, the matrix having a plurality of segments; and
determining contrast differences between the plurality of segments.

18. The method of claim 17, further comprising:
identifying a portion of adjacent segments in the plurality of segments that have contrast differences that meet a threshold; and
determining to attach the second label to the surface of the package that corresponds to the portion of adjacent segments determined to meet the threshold.

19. The method of claim 9, wherein the one or more geometric characteristics comprise one or more of: dimensions of the package, an elevation of the package, a leading edge of the package, an angle of the package, dimensions of the first label, an angle of the first label, or dimensions of a machine-readable identifier of the first label.

20. One or more computer-readable storage media storing computer-usable instructions that when used by a computing device, cause the computing device to perform a method, the method comprising:
receiving one or more images of a package;
determining, via one or more processors, one or more geometric characteristics of the package and a first label attached to a surface of the package based on the one or more images of the package;
causing a second label to be printed using a printing device; and
based on the one or more geometric characteristics determined, causing the second label to be attached, by controlling an applicator device, to the surface of the package in alignment with and adjacent to the first label.
